(19) United States
(12) Patent Application Publication
(10) Pub. No.: US 2025/0357995 A1
(43) Pub. Date: Nov. 20, 2025

(54) INFORMATION PROCESSING METHOD, APPARATUS, COMMUNICATION DEVICE, AND STORAGE MEDIUM

(71) Applicant: Beijing Xiaomi Mobile Software Co., Ltd., Beijing (CN)

(72) Inventors: Yuxin MAO, Beijing (CN); Jinhua WU, Beijing (CN)

(73) Assignee: Beijing Xiaomi Mobile Software Co., Ltd., Beijing (CN)

(21) Appl. No.: 18/871,695

(22) PCT Filed: Jun. 17, 2022
(86) PCT No.: PCT/CN2022/099602

§ 371 Date: Dec. 4, 2024

(51) Int. Cl. H04B 7/185

(52) U.S. Cl. CPC H04B 7/185

(57) ABSTRACT

An information processing method includes sending a request to a network data analytics function (NWDAF), where the request is used for requesting satellite coverage information of a user equipment (UE).

### CROSS-REFERENCE TO RELATED APPLICATION

The present application is a U.S. National Stage of International Application No. PCT/CN2022/099602, filed on Jun. 17, 2022, the entire content of which is incorporated herein by reference for all purposes.

### TECHNICAL FIELD

The present disclosure relates to, but is not limited to, the field of wireless communication technologies, and in particular relates to an information processing method and apparatus, a communication device, and a storage medium.

### BACKGROUND

In satellite networks, if satellite access provides network services for a user equipment (UE), the satellite access may be affected by the insufficient number of satellites in the satellite chain or the interrupted satellite beam, etc., and the signal coverage provided by the satellite access to the ground may be non-continuous.

### SUMMARY

Embodiments of the present disclosure provide an information processing method and apparatus, a communication device, and a storage medium.

According to a first aspect of the present disclosure, there is provided an information processing method, performed by an application function (AF), including: sending a request to a network data analytics function (NWDAF), where the request is used for requesting satellite coverage information of a UE.

According to a second aspect of the present disclosure, there is provided an information processing method, performed by an NWDAF, including:
receiving a request sent by an AF, where the request is used for requesting satellite coverage information of a UE.

According to a third aspect of the present disclosure, there is provided a communication device. The communication device includes:
a processor; and
a memory, configured to store an executable instruction of the processor; where the processor, when running the executable instruction, is configured to implement the information processing method of any embodiment of the present disclosure.

According to a fourth aspect of the present disclosure, there is provided a computer storage medium, where the computer storage medium stores an executable program of a computer, and the executable program, when executed by a processor, implements the information processing method of any embodiment of the present disclosure.

It should be understood that the above general description and the later detailed description are only exemplary and explanatory, and cannot limit the embodiments of the present disclosure.

### BRIEF DESCRIPTION OF THE DRAWINGS

FIG. 1 is a schematic diagram of a structure of a wireless communication system illustrated according to an exemplary embodiment.

FIG. 2 is a schematic diagram of an information processing method illustrated according to an exemplary embodiment.

FIG. 3 is a schematic diagram of an information processing method illustrated according to an exemplary embodiment.

FIG. 4 is a schematic diagram of an information processing method illustrated according to an exemplary embodiment.

FIG. 5 is a schematic diagram of an information processing method illustrated according to an exemplary embodiment.

FIG. 6 is a schematic diagram of an information processing method illustrated according to an exemplary embodiment.

FIG. 7 is a schematic diagram of an information processing method illustrated according to an exemplary embodiment.

FIG. 8 is a block diagram of an information processing apparatus illustrated according to an exemplary embodiment.

FIG. 9 is a block diagram of an information processing apparatus illustrated according to an exemplary embodiment.

FIG. 10 is a block diagram of a UE illustrated according to an exemplary embodiment.

FIG. 11 is a block diagram of a base station illustrated according to an exemplary embodiment.

### DETAILED DESCRIPTION

The exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present disclosure. On the contrary, they are only examples of devices and methods consistent with some aspects of the embodiments of the present disclosure as detailed in the appended claims.

The terms used in the embodiments of the present disclosure are used solely for the purpose of describing particular embodiments, but are not intended to limit the embodiments of the present disclosure. The singular forms of “a” and “the” used in the embodiments of the present disclosure and the appended claims are also intended to include the plural form, unless the context clearly indicates other meanings. It should also be understood that the term “and/or” as used in this article refers to and includes any or all possible combinations of one or more of the associated listed items.

It should be understood that although the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” as used herein may be interpreted as “at the time of . . . ”, “when . . . ”, or “in response to determining”.

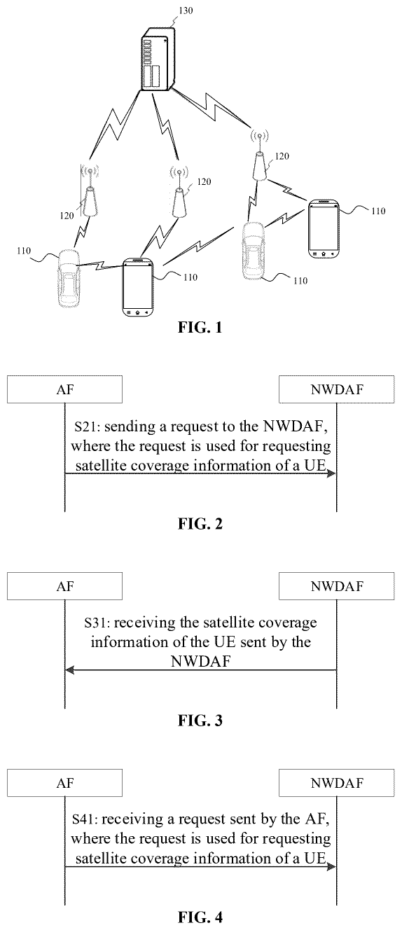

Referring to FIG. 1, a schematic diagram of a structure of a wireless communication system provided in an embodiment of the present disclosure is shown. As shown in FIG. 1, the wireless communication system is a communication system based on cellular mobile communication technologies, and the wireless communication system may include one or more UEs 110, and one or more base stations 120.

In some embodiments, the UE 110 may be a device that provides voice and/or data connectivity to a user. The UE 110 may communicate with one or more core networks via a radio access network (RAN). The UE 110 may be an IoT (internet of things) UE, such as a sensor device, a mobile phone (or referred to as a “cellular” phone), or a computer with an IoT UE. For example, the UE 110 may be a fixed, portable, pocket, handheld, computer built-in, or vehicle-mounted device. For example, the UE 110 may be a station (STA), a subscriber unit, a subscriber station, a mobile station, a mobile, a remote station, an access point, a remote UE (remote terminal), an access UE (access terminal), a user device (user terminal), a user agent, a user device, or a user equipment. Or, the UE 110 may be a device of an unmanned aerial vehicle. Or, the UE 110 may be a vehicle-mounted device, such as a trip computer with wireless communication functions, or a wireless UE externally connected to a trip computer. Or, the UE 110 may be a road side device, such as a street light, a signal light, or other road side devices with wireless communication functions.

The base station 120 may be a network side device in the wireless communication system. In some embodiments, the wireless communication system may be the 4th generation mobile communication (4G) system, also referred to as the long term evolution (LTE) system. Or, the wireless communication system may be a 5G system, also referred to as a new radio (NR) system or a 5G NR system. Or, the wireless communication system may be the next generation system of the 5G system. In some embodiments, the access network in the 5G system may be referred to as a new generation-radio access network (NG-RAN).

In some embodiments, the base station 120 may be an evolved base station (eNB) used in a 4G system. Or, the base station 120 may be a base station (gNB) with a centralized distributed architecture in a 5G system. When adopting the centralized distributed architecture, the base station 120 typically includes a central unit (CU) and at least two distributed units (DUs). The central unit is provided with a protocol stack of a packet data convergence protocol (PDCP) layer, a radio link control (RLC) layer, and a medium access control (MAC) layer. The distributed unit is provided with a protocol stack of a physical (PHY) layer. The embodiments of the present disclosure do not limit the specific implementations of the base station 120.

A wireless connection may be established between the base station 120 and the UE 110 via a wireless air interface. In a different embodiment, the wireless air interface is a wireless air interface based on a 4G standard. Or, the wireless air interface is a wireless air interface based on a 5G standard, for example, the wireless air interface is a new air interface. Or, the wireless air interface may also be a wireless air interface based on the next generation mobile communication network technology standard of 5G.

In some embodiments, an end to end (E2E) connection may also be established between UEs 110. For example, scenarios such as vehicle to vehicle (V2V) communications, vehicle to infrastructure (V2I) communications, and vehicle to pedestrian (V2P) communications in the vehicle to everything (V2X) communications.

Here, the above-described UE may be considered as the terminal device of the following embodiments.

In some embodiments, the above-described wireless communication system may further include a network management device 130.

One or more base stations 120 are connected to the network management device 130 respectively. In some embodiments, the network management device 130 may be a core network device in the wireless communication system, for example, the network management device 130 may be a mobility management entity (MME) in the evolved packet core (EPC). Alternatively, the network management device may also be other core network devices, such as a service gateway (SGW), a public data network gateway (PGW), a policy and charging rules function (PCRF), or a home subscriber server (HSS). The implementation forms of the network management device 130 are not limited in the embodiments of the present disclosure.

In order to facilitate the understanding of those skilled in the art, the embodiments of the present disclosure enumerate a plurality of embodiments to provide a clear description of the technical solutions of the embodiments of the present disclosure. Of course, those skilled in the art can understand that the plurality of embodiments provided by the embodiments of the present disclosure may be performed individually or in combination with the methods of other embodiments in the embodiments of the present disclosure, or may be performed individually or in combination with some methods of other related arts. The embodiments of the present disclosure do not limit this.

In order to better understand the technical solution described in any of the embodiments of the present disclosure, first, a partial description for the related art is provided.

When the UE accesses the network via the satellite in a certain area, there is a case of no satellite signal coverage in a certain time period. Therefore, the UE needs to consider the non-continuous coverage of the satellite access in the process of accessing the network and conducting a service. In the case where there is the non-continuous coverage in the satellite access, in order to enable the service to be carried out normally, it is required to sense the satellite coverage information of the UE. Currently, the network device cannot accurately obtain the satellite coverage information of the UE. In some application scenarios, non-continuous coverage of the satellite access needs to be considered. For example, when the UE is not provided with the satellite signal coverage, the UE is made to be in a dormant or power-saving state to save the power consumption of the UE. When the UE resumes the satellite signal coverage, the UE may wake up in time and re-establish a connection with the network or conduct a service. For another example, when the network device sends signaling and/or data to the UE, the network device needs to determine whether the UE is reachable at this timepoint. If the UE is in an area with signal coverage and the UE is reachable, the network device sends the signaling and/or data to the UE. If the UE is in an area with no signal coverage, the network device caches the signaling and/or data. When the network device determines that the coverage of the satellite signal is resumed for the UE, the network device sends the signaling/data to the UE. In short, in the case where the UE uses the satellite to access the network and there is non-continuous coverage in the satellite access, when the UE and the network device send the signaling and/or data, both the UE and the network device need to determine, based on the satellite coverage, whether the UE is reachable, and the communication interaction is carried out only when the UE is reachable.

In an embodiment, an AF needs to sense satellite coverage information of the UE. For example, before a service with a relatively long interaction time is initiated, the AF may obtain the satellite coverage information of the UE from the network device, and determine, based on the network coverage information of the UE, whether to conduct the service currently. In this way, a situation in which the UE transitions to no signal coverage before the service is ended can be reduced.

In an embodiment, the AF obtains the satellite coverage information of the UE from a current service network (e.g., a public land mobile network (PLMN)) of the UE, and determines a service related operation based on the satellite coverage information of the UE. The service related operation may be whether to conduct a service and/or when to conduct a service. However, the service network can only obtain satellite coverage information of the satellite access currently used by the UE. For example, if a switching of the access network and/or the service network occurs, the AF cannot accurately obtain the satellite coverage information of the UE.

As shown in FIG. 2, the embodiments of the present disclosure provide an information processing method that is performed by an AF and includes step S21.

At step S21, a request is sent to an NWDAF, where the request is used for requesting satellite coverage information of a UE.

Here, the UE may be various mobile terminals or fixed terminals. For example, the UE may be, but is not limited to, a cell phone, a computer, a server, a wearable device, a vehicle-mounted terminal, a road side unit (RSU), a game control platform, or a multimedia device.

Here, the AF, and the NWDAF, network exposure function (NEF), and user plane function (UPF) involved in the following embodiments may be logical nodes or functions, etc., that can be flexibly deployed in a communication network. Specifically, the NWDAF, NEF and UPF are logical nodes or functions at the core network side, and the AF is a core network side or third-party node or function.

In an embodiment, the request is further used for indicating reachability information of the UE. Here, the request being used for indicating the reachability information of the UE may be that the request is used for requesting the reachability information of the UE.

Here, the request is used for requesting the satellite coverage information of the UE for one of the following events: a satellite coverage information event of the UE, and a reachability information event of the UE.

Here, the AF requests from the NWDAF, based on the request, the satellite coverage information of the satellite coverage information event of the UE, then the NWDAF sends the satellite coverage information of the UE to the AF; alternatively, the AF requests from the NWDAF, based on the request, the satellite coverage information of the reachability information event of the UE, then the NWDAF sends the satellite coverage information of the UE to the AF, or sends the satellite coverage information of the UE and the reachability information of the UE to the AF.

In an embodiment, the request sent to the NWDAF in step S21 may be a subscription request.

In an embodiment, the satellite coverage information may be, but is not limited to, a satellite coverage duration and/or a satellite non-coverage duration. Here, the satellite coverage duration may be a duration that a certain area is covered by a satellite signal. The satellite coverage duration may also be a start time of the satellite signal coverage and/or an end time of the satellite signal coverage. Here, the satellite non-coverage duration may be a duration that a certain area is not covered by a satellite signal. The satellite non-coverage duration may also be a start time of no satellite signal coverage and/or an end time of no satellite signal. The satellite coverage involved in the embodiments of the present disclosure may be satellite signal coverage; and the satellite non-coverage may be the absence of the satellite signal coverage.

In another embodiment, the satellite coverage information may also be other information, as long as the satellite coverage duration and/or the satellite non-coverage duration can be determined based on the satellite coverage information. There are no limitations on the satellite coverage information here.

Here, the reachability information of the UE may be information related to the reachable satellite signal coverage area of the UE.

In an embodiment, the reachability information of the UE is the time of the reachable satellite signal coverage area of the UE; or the reachability information of the UE is the time of the reachable satellite signal coverage area and the satellite signal coverage area of the UE.

For example, the AF sends the request to the NWDAF, and the request is used for requesting the satellite coverage information of the UE; then the NWDAF may return the satellite coverage information of the UE to the AF.

For example, the AF sends the request to the NWDAF, and the request is further used for indicating the reachability information of the UE; then the NWDAF may return the reachability information of the UE and the satellite coverage information of the UE to the AF, or the NWDAF returns the satellite coverage information of the UE to the AF.

In the embodiments of the present disclosure, through sending the request to the NWDAF by the AF, where the request is used for requesting the satellite coverage information of the UE, the AF can be enabled to accurately obtain the satellite coverage information of the UE. In this way, it is advantageous for the UE to determine, based on the satellite coverage information as obtained, whether the UE is provided with the satellite signal coverage. Thus, when service interaction is performed between the network device and the UE, it is advantageous for the network device and the UE to perform, based on whether the UE is provided with the satellite signal coverage, effective service interaction.

For example, when it is determined that the UE is not provided with the satellite signal coverage, the UE is made to be in a dormant or power-saving state, and/or the network device is made not to send data and/or signaling to the UE. Thus, the power consumption of the UE and the power consumption of the network device, etc. can be saved, and the probability that the UE does not monitor the data and/or signaling sent by the network device can be reduced. As another example, when it is determined that the UE is provided with the satellite signal coverage, the UE may be made to be in a wake-up state, and/or the network device may be made to send data and/or signaling to the UE. Thus, the probability that the UE monitors the data and/or signaling sent by the network device can be increased.

The embodiments of the present disclosure provide an information processing method that is performed by the AF and includes:

determining, based on the satellite coverage information of the UE, whether the UE conducts a service in a current coverage time range; and/or determining, based on the satellite coverage information of the UE, whether the UE conducts a service in a next coverage time range.

Here, each of the current coverage time range and the next coverage time range may be a time range with a preset duration. Here, the preset duration may be any duration. For example, the preset duration may be, but is not limited to, 30 seconds, 1 minute, 2 minutes, 5 minutes, 10 minutes, 20 minutes, 30 minutes, 1 hour, 2 hours, 5 hours, 10 hours, or 1 day. There are no limitations on the preset duration here.

In an embodiment, the next coverage time range may be a time range with any preset duration.

Here, the duration of the current coverage time range and the duration of the next coverage time range may be the same or different. For example, the duration of the current coverage time range may be 10 minutes, and the duration of the next coverage time range may be 10 minutes. As another example, the duration of the current coverage time range may be 10 minutes, and the duration of the next coverage time range may be 20 minutes.

Here, conducting a service may be, but is not limited to, receiving and/or sending information, and performing a service related operation. Here, the information includes, but is not limited to, signaling and/or data.

For example, if the AF determines, based on the satellite coverage duration in the satellite coverage information of the UE, that there is satellite signal coverage in the current coverage time range, the AF determines to conduct a service in the current coverage time range. Alternatively, if the AF determines, based on the satellite non-coverage duration in the satellite coverage information of the UE, that there is no satellite signal in the current coverage time range, the AF determines not to conduct a service in the current coverage time range.

For example, if the AF determines, based on the satellite coverage duration in the satellite coverage information of the UE, that there is satellite signal coverage in the next coverage time range, the AF determines to conduct a service in the next coverage time range. Alternatively, if the AF determines, based on the satellite non-coverage duration in the satellite coverage information of the UE, that there is no satellite signal in the next coverage time range, the AF determines not to conduct a service in the next coverage time range.

In this way, in the embodiments of the present disclosure, the AF may determine, based on the satellite coverage information of the UE, whether the UE is capable of conducting a service in the current coverage time range and/or the next coverage time range. Thus, the effectiveness of service conduction can be improved, and the power consumption of the UE, etc. can be saved.

The embodiments of the present disclosure provide an information processing method that is performed by the AF and includes: determining, based on the satellite coverage information of the UE, whether the UE is provided with the satellite signal coverage in a preset duration range. Here, through the determination of whether there is the satellite signal coverage in the preset duration range, whether the UE is capable of conducting a service in the preset duration range may be determined.

It should be noted that those skilled in the art can understand that the methods provided in the embodiments of the present disclosure may be performed individually or in combination with some methods in the embodiments of the present disclosure or some methods in the related art.

In some embodiments, step S21 includes sending the request to the NWDAF via an NEF.

The embodiments of the present disclosure provide an information processing method that is performed by the AF and includes: sending the request to the NWDAF via the NEF.

Here, sending, by the AF, the request to the NWDAF via the NEF may be that the AF sends the request to the NEF, and the NEF forwards the request to the NWDAF.

Of course, in other embodiments, the AF may also send the request to the NWDAF via other logical nodes or functions in the communication device.

In this way, the request sent by the AF can be forwarded through the NEF or other logical nodes or functions, etc., enabling the request to be efficiently sent to the NWDAF.

It should be noted that those skilled in the art can understand that the methods provided in the embodiments of the present disclosure may be performed individually or in combination with some methods in the embodiments of the present disclosure or some methods in the related art.

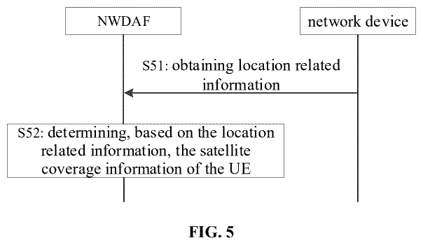

As shown in FIG. 3, the embodiments of the present disclosure provide an information processing method that is performed by the AF and includes step S31.

At step S31, the satellite coverage information of the UE sent by the NWDAF is received.

In some embodiments of the present disclosure, the satellite coverage information may be the satellite coverage information in step S21. For example, the satellite coverage information may be, but is not limited to, a satellite coverage duration and/or a satellite non-coverage duration.

In an embodiment, step S31 may be: receiving the satellite coverage information of the UE sent by the NWDAF.

In an embodiment, step S31 may be: receiving an event report sent by the NWDAF, where the event report includes the satellite coverage information of the UE.

In an embodiment, the event report further includes the reachability information of the UE.

In an embodiment, the satellite coverage information of the UE is determined based on the location related information. For example, the satellite coverage information of the UE is determined by the NWDAF based on the location related information.

In an embodiment, the location related information may be, but is not limited to, at least one of the following: ephemeris information of a satellite accessed by the UE, location information of the UE, movement trajectory information of the UE.

For example, the satellite coverage information of the UE is determined based on the ephemeris information of the satellite accessed by the UE, and the location information of the UE.

For example, the satellite coverage information of the UE is determined based on the ephemeris information of the satellite accessed by the UE, and the movement trajectory information of the UE.

For example, the satellite coverage information of the UE is determined based on the ephemeris information of the satellite accessed by the UE, the location information of the UE, and the movement trajectory information of the UE.

In this way, in the embodiments of the present disclosure, a plurality of ways to determine the satellite coverage information of the UE are provided, adapting to more application scenarios.

In some embodiments, step S31 includes: receiving, via an NEF, the satellite coverage information of the UE sent by the NWDAF.

The embodiments of the present disclosure provide an information processing method that is performed by the AF and includes: receiving, via the NEF, the satellite coverage information of the UE sent by the NWDAF.

Here, receiving, by the AF via the NEF, an event report sent by the NWDAF may be that the NEF receives the satellite coverage information of the UE sent by the NWDAF, and sends the satellite coverage information of the UE to the AF.

Of course, in other embodiments, the AF may also receive the satellite coverage information sent by the NWDAF via other logical nodes or functions in the communication device.

In this way, the satellite coverage information of the UE sent by the NWDAF can be forwarded through the NEF or other logical nodes or functions, etc., enabling the AF to successfully receive the satellite coverage information of the UE.

It should be noted that those skilled in the art can understand that the methods provided in the embodiments of the present disclosure may be performed individually or in combination with some methods in the embodiments of the present disclosure or some methods in the related art.

In some embodiments, sending the request to the NWDAF in step S21 includes: sending the request to the NWDAF when the UE performs a service network switching or accesses a service network.

The embodiments of the present disclosure provide an information processing method that is performed by the AF and includes: sending the request to the NWDAF when the UE performs the service network switching or accesses the service network.

Here, the NWDAF may be, but is not limited to, at least one of the following: a source network data analytics function (S-NWDAF), a target network data analytics function (T-NWDAF), a home network data analytics function (H-NWDAF).

Here, performing the service network switching may be switching from a first service network to a second service network. Here, accessing the service network may be accessing any network, for example, may be accessing the second service network.

Here, the first service network and the second service network may be any type of network. For example, each of the first service network and the second service network may be a PLMN.

In an embodiment, the first service network is a service network before the switching of the UE, and the second service network is a service network after the switching or accessing of the UE. Here, the first service network is a source service network, and the second service network is a target service network.

In an embodiment, the NWDAF of the first service network is an S-NWDAF, and the NWDAF of the second service network is a T-NWDAF.

Here, the H-NWDAF may be the NWDAF of the home network of the UE.

In some embodiments, the NWDAF includes an H-NWDAF; and
sending the request to the NWDAF in step S21 includes:
sending the request to the H-NWDAF before the UE is switched from the first service network to the second service network.

The embodiments of the present disclosure provide an information processing method that is performed by the AF and includes: sending the request to the H-NWDAF before the UE is switched from the first service network to the second service network.

Of course, in other embodiments, the AF may also send the request to the H-NWDAF after the UE is switched from the first service network to the second service network.

In some embodiments of the present disclosure, the request may be the request in the above embodiments; the satellite coverage information of the UE may be the satellite coverage information of the UE in the above embodiments; and the location related information may be the location related information in the above embodiments.

In some embodiments, receiving the satellite coverage information of the UE sent by the NWDAF in step S31 includes:
receiving, before the UE is switched from the first service network to the second service network, the satellite coverage information of the UE sent by the H-NWDAF, where the satellite coverage information of the UE is determined by the H-NWDAF based on the location related information obtained from the NWDAF of the first service network; and/or
receiving, after the UE is switched from the first service network to the second service network, the satellite coverage information of the UE sent by the H-NWDAF, where the satellite coverage information of the UE is determined by the H-NWDAF based on the location related information obtained from the NWDAF of the second service network.

The embodiments of the present disclosure provide an information processing method that is performed by the AF and includes:
receiving, before the UE is switched from the first service network to the second service network, the satellite coverage information of the UE sent by the H-NWDAF, where the satellite coverage information of the UE is determined by the H-NWDAF based on the location related information obtained from the NWDAF of the first service network; and/or
receiving, after the UE is switched from the first service network to the second service network, the satellite coverage information of the UE sent by the H-NWDAF, where the satellite coverage information of the UE is determined by the H-NWDAF based on the location related information obtained from the NWDAF of the second service network.

For example, the AF sends, before the UE is switched from the first service network to the second service network, the request to the H-NWDAF, where the request is used for requesting the satellite coverage information of the UE; and the AF receives, before the UE is switched from the first service network to the second service network, the satellite coverage information of the UE sent by the H-NWDAF, where the H-NWDAF determines the satellite coverage information based on the location related information obtained from the NWDAF of the first service network. The AF receives, after the UE is switched from the first service network to the second service network, the satellite coverage information of the UE sent by the H-NWDAF, where the H-NWDAF determines the satellite coverage information based on the location related information obtained from the NWDAF of the second service network.

In this way, in the embodiments of the present disclosure, the AF may request, by sending the request to the H-NWDAF of the home network, the satellite coverage information of the UE. The H-NWDAF may obtain, before the switching of the UE, the satellite coverage information of the UE from the source service network and send the satellite coverage information to the AF; and/or the H-NWDAF may obtain, after the switching of the UE, the satellite coverage information of the UE from the target service network and send the satellite coverage information to the AF. In this way, the accurately obtaining of the satellite coverage information of the UE by the AF can be achieved.

In some embodiments, the NWDAF includes the NWDAF of the first service network; and
sending the request to the NWDAF in step S21 includes:
sending, before the UE is switched from the first service network to the second service network, the request to the NWDAF of the first service network.

The embodiments of the present disclosure provide an information processing method that is performed by the AF and includes: sending, before the UE is switched from the first service network to the second service network, the request to the NWDAF of the first service network.

In some embodiments, receiving the satellite coverage information of the UE sent by the NWDAF in step S31 includes:
receiving, before the UE is switched from the first service network to the second service network, the satellite coverage information of the UE sent by the NWDAF of the first service network, where the satellite coverage information of the UE is determined by the NWDAF of the first service network based on the location related information as obtained; and/or
receiving, after the UE is switched from the first service network to the second service network, the satellite coverage information of the UE sent by the NWDAF of the first service network, where the satellite coverage information of the UE is determined by the NWDAF of the first service network based on the location related information obtained from the NWDAF of the second service network.

For example, the AF sends, before the UE is switched from the first service network to the second service network, the request to the NWDAF (e.g., S-NWDAF) of the first service network, where the request is used for requesting the satellite coverage information of the UE; and the AF receives, before the UE is switched from the first service network to the second service network, the satellite coverage information of the UE sent by the NWDAF of the first service network, where the satellite coverage information is determined based on the location related information obtained by the NWDAF of the first service network. The AF receives, after the UE is switched from the first service network to the second service network, the satellite coverage information of the UE sent by the NWDAF of the first service network, where the NWDAF of the first service network determines the satellite coverage information based on the location related information obtained from the NWDAF of the second service network.

In this way, in the embodiments of the present disclosure, the AF may request, by sending the request to the S-NWDAF of the service network before the switching, the satellite coverage information of the UE. The S-NWDAF may obtain, before the switching of the UE, the satellite coverage information of the UE from the source service network and send the satellite coverage information to the AF; and/or the S-NWDAF may obtain, after the switching of the UE, the satellite coverage information of the UE from the target service network and send the satellite coverage information to the AF. In this way, the accurately obtaining of the satellite coverage information of the UE by the AF can be achieved.

It should be noted that those skilled in the art can understand that the methods provided in the embodiments of the present disclosure may be performed individually or in combination with some methods in the embodiments of the present disclosure or some methods in the related art.

An information processing method in the following is performed by an NWDAF, and is similar to the above description of the information processing method performed by the AF. For technical details not disclosed in the embodiments of the information processing method performed by the NWDAF, please refer to the description of the examples of the information processing method performed by the AF, which will not be described and illustrated in detail here.

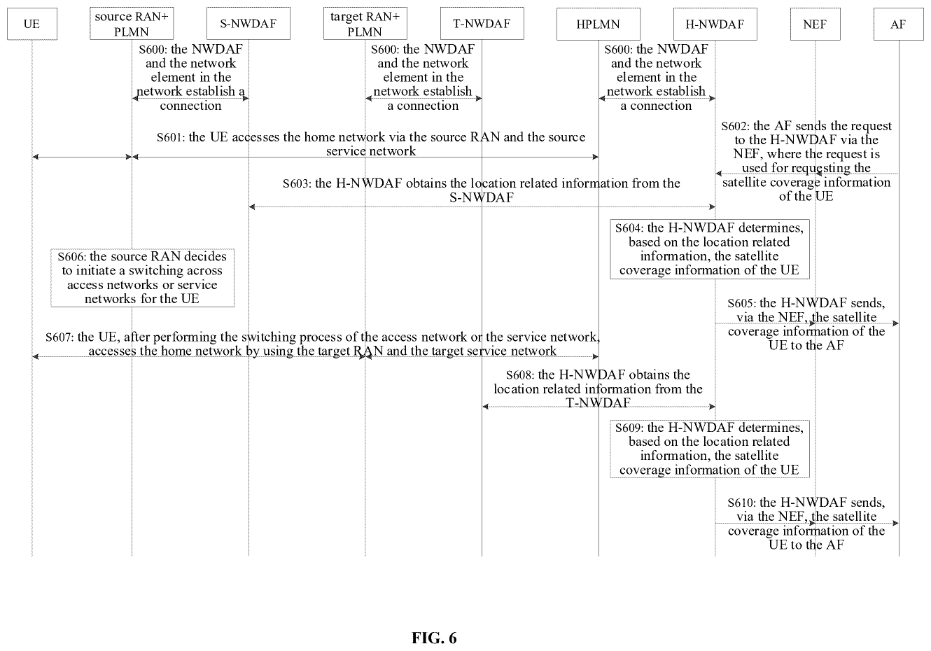

As shown in FIG. 4, the embodiments of the present disclosure provide an information processing method that is performed by an NWDAF and includes step S41.

At step S41, a request sent by an AF is received, where the request is used for requesting satellite coverage information of a UE.

In some embodiments of the present disclosure, the request may be the request in step S21, and the satellite coverage information may be the satellite coverage information in step S21.

For example, the request is further used for indicating reachability information of the UE.

For example, the request is a subscription request.

For example, the request is used for requesting the satellite coverage information of the UE for one of the following events: satellite coverage information of the UE, and reachability information of the UE.

For example, the satellite coverage information may be, but is not limited to, a satellite coverage duration and/or a satellite non-coverage duration.

In some embodiments, receiving the request sent by the AF in step S41 includes: receiving, via an NEF, the request sent by the AF.

The embodiments of the present disclosure provide an information processing method that is performed by the NWDAF and includes: sending an event report to the AF, where the event report includes the satellite coverage information of the UE.

The embodiments of the present disclosure provide an information processing method that is performed by the NWDAF and includes: sending the satellite coverage information of the UE to the AF.

In some embodiments, sending the satellite coverage information of the UE to the AF includes: sending, via the NEF, the satellite coverage information of the UE to the AF.

The embodiments of the present disclosure provide an information processing method that is performed by the NWDAF and includes: sending, via the NEF, the satellite coverage information of the UE to the AF.

The above embodiments can be specifically referred to the description for the AF side, and will not be repeated here.

The embodiments of the present disclosure provide an information processing method that is performed by the NWDAF and includes: determining the satellite coverage information of the UE.

The embodiments of the present disclosure provide an information processing method that is performed by the NWDAF and includes: determining, based on the request, the satellite coverage information of the UE. In this way, in the embodiments of the present disclosure, the satellite coverage information of the UE can be determined upon receipt of the request.

In some embodiments, the method includes: obtaining location related information; and
determining the satellite coverage information of the UE includes: determining, based on the location related information, the satellite coverage information of the UE.

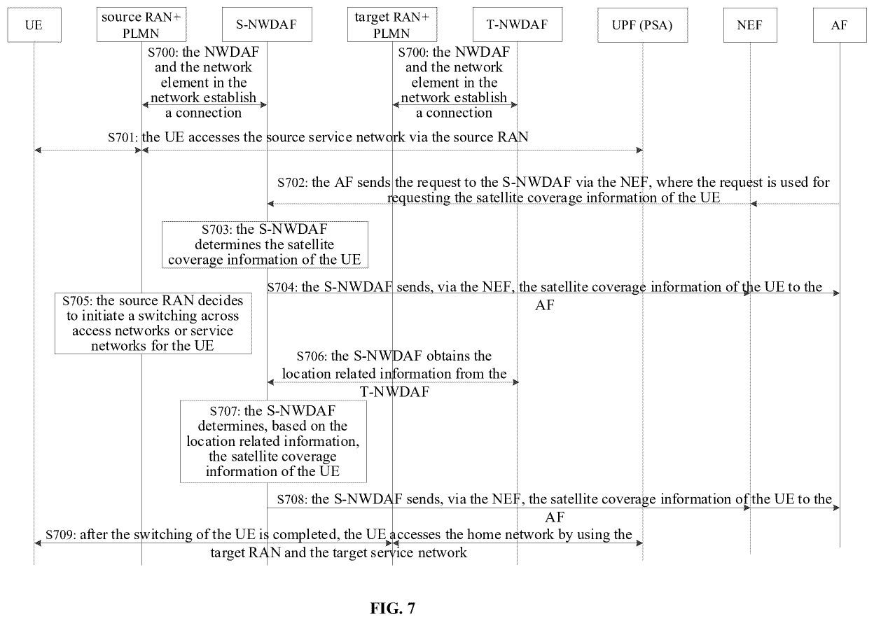

As shown in FIG. 5, the embodiments of the present disclosure provide an information processing method that is performed by the NWDAF and includes steps S51 and S52.

At step S51, location related information is obtained.

At step S52, the satellite coverage information of the UE is determined based on the location related information.

Here, the location related information includes, but is not limited to, at least one of the following: ephemeris information of a satellite accessed by the UE, location information of the UE, movement trajectory information of the UE.

In some embodiments, S52 includes one of the following:
determining the satellite coverage information based on the ephemeris information and the location information;
determining the satellite coverage information based on the ephemeris information and the movement trajectory information of the UE;
determining the satellite coverage information based on the ephemeris information, the location information and the movement trajectory information.

The embodiments of the present disclosure provide an information processing method that is performed by the NWDAF and includes:

determining the satellite coverage information based on the ephemeris information and the location information;
determining the satellite coverage information based on the ephemeris information and the movement trajectory information of the UE; or determining the satellite coverage information based on the ephemeris information, the location information and the movement trajectory information.

In this way, in the embodiments of the present disclosure, a plurality of ways to determine the satellite coverage information are provided, adapting to more application scenarios.

In some embodiments of the present disclosure, the NWDAF may be the NWDAF of the above embodiments. For example, the NWDAF may be, but is not limited to, at least one of the following: an S-NWDAF, a T-NWDAF, an H-NWDAF. For example, the NWDAF may, but is not limited to, the NWDAF of a first service network, and/or the NWDAF of a second service network.

In some embodiments, the NWDAF includes an H-NWDAF; and
obtaining the location related information includes at least one of the following:
obtaining, before the UE is switched from the first service network to the second service network, the location related information from the NWDAF of the first service network;
obtaining, after the UE is switched from the first service network to the second service network, the location related information from the NWDAF of the second service network.

The embodiments of the present disclosure provide an information processing method that is performed by an H-NWDAF and includes at least one of the following:
obtaining, before the UE is switched from the first service network to the second service network, the location related information from the NWDAF of the first service network;
obtaining, after the UE is switched from the first service network to the second service network, the location related information from the NWDAF of the second service network.

Here, the NWDAF of the first service network is the S-NWDAF of the source service network. The NWDAF of the second service network is the T-NWDAF of the target service network.

In an embodiment of the present disclosure, if the NWDAF is an H-NWDAF, the H-NWDAF may obtain, before the UE performs the service network switching, the location related information from the S-NWDAF to determine the satellite coverage information of the UE, and/or the H-NWDAF may obtain, after the UE performs the service network switching, the location related information from the T-NWDAF to determine the satellite coverage information of the UE. In this way, accurate satellite coverage information of the UE can be provided to the AF.

In some embodiments, the NWDAF includes an S-NWDAF; and obtaining the location related information includes obtaining the location related information from the T-NWDAF.

The embodiments of the present disclosure provide an information processing method that is performed by an S-NWDAF and includes: obtaining the location related information from the H-NWDAF.

The embodiments of the present disclosure provide an information processing method that is performed by the S-NWDAF and includes at least one of the following:
obtaining, before the UE is switched from the first service network to the second service network, the location related information;
obtaining, after the UE is switched from the first service network to the second service network, the location related information from the H-NWDAF.

In the embodiments of the present disclosure, if the NWDAF is an S-NWDAF, the S-NWDAF may obtain, before the UE performs the service network switching, the location related information to determine the satellite coverage information of the UE, and/or the S-NWDAF may obtain, after the UE performs the service network switching, the location related information from the T-NWDAF to determine the satellite coverage information of the UE. In this way, accurate satellite coverage information of the UE can be provided to the AF.

The above embodiments can be specifically referred to the description for the AF side, and will not be repeated here.

It should be noted that those skilled in the art can understand that the methods provided in the embodiments of the present disclosure may be performed individually or in combination with some methods in the embodiments of the present disclosure or some methods in the related art.

To further explain any of the embodiments of the present disclosure, several specific embodiments are provided below.

### EXAMPLE 1

In some application scenarios, as shown in FIG. 6, the UE undergoes a switching across access networks or service networks, the source RAN+PLMN indicates the access network and the service network used by the UE before the switching, the S-NWDAF is the NWDAF in the source service network, the target RAN+PLMN indicates the access network and the service network used by the UE after the switching, the T-NWDAF is the NWDAF after the switching, and the HPLMN is the home network of the UE. Here, the service network used before the switching is the source service network, and the service network used after the switching is the target service network. As shown in FIG. 6, the embodiments of the present disclosure provide an information processing method that is performed by a communication device and includes steps S600 to S610.

At step S600, the NWDAF and the network element in the network establish a connection.

Here, the NWDAF may be, but is not limited to, at least one of the following: an S-NWDAF, a T-NWDAF, an H-NWDAF.

At step S601, the UE accesses the home network via the source RAN and the source service network.

Here, the source RAN may be a first satellite access network.

At step S602, the AF sends the request to the H-NWDAF via the NEF, where the request is used for requesting the satellite coverage information of the UE.

Here, the AF may obtain, based on the satellite coverage information of the UE, the satellite coverage duration and the satellite non-coverage duration of the UE.

In an optional embodiment, the request is used for requesting an event report, where the event report includes the satellite coverage information of the UE.

At step S603, the H-NWDAF obtains the location related information from the S-NWDAF.

In an optional embodiment, the H-NWDAF determines, based on the request sent by the AF, that there is a need to obtain the satellite coverage information of the UE; then the H-NWDAF obtains the location related information from the S-NWDAF, where the location related information includes at least one of the following: ephemeris information of a satellite accessed by the UE, location information of the UE, movement trajectory information of the UE.

At step S604, the H-NWDAF determines, based on the location related information, the satellite coverage information of the UE.

In an optional embodiment, the H-NWDAF determines the satellite coverage information based on the ephemeris information and the location information; alternatively, the H-NWDAF determines the satellite coverage information based on the ephemeris information and the movement trajectory information. Or, the H-NWDAF determines the satellite coverage information based on the ephemeris information, the location information and the movement trajectory information.

At step S605, the H-NWDAF sends, via the NEF, the satellite coverage information of the UE to the AF.

Here, the AF may determine, based on the satellite coverage information, whether to conduct a service in the current coverage time range; and/or the AF may determine, based on the satellite coverage information, whether to conduct a service in the next coverage time range.

At step S606, the source RAN decides to initiate a switching across access networks or service networks for the UE.

Here, the access network may be an RAT, etc., and the service network may be a PLMN, etc.

At step S607, the UE, after performing the switching process of the access network or the service network, accesses the home network by using the target RAN and the target service network.

Here, the target RAN is a second satellite access network. The target RAN is different from the source RAN.

At step S608, the H-NWDAF obtains the location related information from the T-NWDAF.

In an optional embodiment, the H-NWDAF, after the switching of the UE is completed, obtains the ephemeris information of the second satellite access network used by the

UE after the switching, the location information of the UE, and the movement trajectory information of the UE.

At step S609, the H-NWDAF determines, based on the location related information, the satellite coverage information of the UE.

At step S610, the H-NWDAF sends, via the NEF, the satellite coverage information of the UE to the AF.

Here, the AF may determine, based on the satellite coverage information, whether to conduct a service in the current coverage time range; and/or the AF may determine, based on the satellite coverage information, whether to conduct a service in the next coverage time range.

### EXAMPLE 2

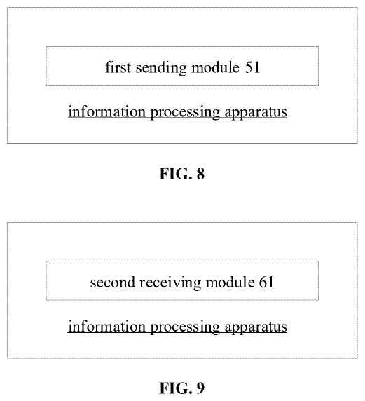

In some application scenarios, as shown in FIG. 7, the UE undergoes a switching across access networks or service networks, the source RAN+PLMN indicates the access network and the service network used by the UE before the switching, the S-NWDAF is the NWDAF in the source service network, the target RAN+PLMN indicates the access network and the service network used by the UE after the switching, the T-NWDAF is the NWDAF after the switching, and the HPLMN is the home network of the UE. Here, the service network used before the switching is the source service network, and the service network used after the switching is the target service network. The UPF (or PSA) is the data plane anchor point for the UE's switching of the access network or the service network. As shown in FIG. 7, the embodiments of the present disclosure provide an information processing method that is performed by a communication device and includes steps S700 to S709.

At step S700, the NWDAF and the network element in the network establish a connection.

Here, the NWDAF may be, but is not limited to, at least one of the following: an S-NWDAF, and a T-NWDAF.

At step S701, the UE accesses the source service network via the source RAN.

Here, the source RAN may be a first satellite access network.

At step S702, the AF sends the request to the S-NWDAF via the NEF, where the request is used for requesting the satellite coverage information of the UE.

Here, the AF may obtain, based on the satellite coverage information of the UE, the satellite coverage duration and the satellite non-coverage duration of the UE.

At step S703, the S-NWDAF determines the satellite coverage information of the UE.

In an optional embodiment, the S-NWDAF determines, based on the request sent by the AF, that there is a need to obtain the satellite coverage information of the UE; then the S-NWDAF obtains the location related information, where the location related information includes at least one of the following: ephemeris information of a satellite accessed by the UE, location information of the UE, movement trajectory information of the UE; and the S-NWDAF determines, based on the location related information, the satellite coverage information of the UE.

Here, determining, based on the location related information, the satellite coverage information of the UE includes: determining, by the S-NWDAF, the satellite coverage information based on the ephemeris information and the location information; or determining, by the S-NWDAF, the satellite coverage information based on the ephemeris information and the movement trajectory information; or determining, by the S-NWDAF, the satellite coverage information based on the ephemeris information, the location information, and the movement trajectory information.

At step S704, the S-NWDAF sends, via the NEF, the satellite coverage information of the UE to the AF.

Here, the AF may determine, based on the satellite coverage information, whether to conduct a service in the current coverage time range; and/or the AF may determine, based on the satellite coverage information, whether to conduct a service in the next coverage time range.

At step S705, the source RAN decides to initiate a switching across access networks or service networks for the UE.

Here, the access network may be an RAT, etc., and the service network may be a PLMN, etc.

Here, the target RAN is a second satellite access network. The target RAN is different from the source RAN.

At step S706, the S-NWDAF obtains the location related information from the T-NWDAF.

In an optional embodiment, the S-NWDAF, after the switching of the UE is completed, obtains the ephemeris information of the second satellite access network used by the UE after the switching, the location information of the UE, and the movement trajectory information of the UE.

At step S707, the S-NWDAF determines, based on the location related information, the satellite coverage information of the UE.

At step S708, the S-NWDAF sends, via the NEF, the satellite coverage information of the UE to the AF.

Here, the AF may determine, based on the satellite coverage information, whether to conduct a service in the current coverage time range; and/or the AF may determine, based on the satellite coverage information, whether to conduct a service in the next coverage time range.

At step S709, after the switching of the UE is completed, the UE accesses the home network by using the target RAN and the target service network.

It should be noted that those skilled in the art can understand that the methods provided in the embodiments of the present disclosure may be performed individually or in combination with some methods in the embodiments of the present disclosure or some methods in the related art.

As shown in FIG. 8, the embodiments of the present disclosure provide an information processing apparatus, including:
a first sending module 51, configured to send a request to an NWDAF, where the request is used for requesting satellite coverage information of a UE.

The information processing apparatus provided by the embodiments of the present disclosure may be applied in an AF.

The embodiments of the present disclosure provide an information processing apparatus, including: a first sending module 51, configured to send the request to the NWDAF via an NEF.

In some embodiments, the request is further used for indicating reachability information of the UE.

The embodiments of the present disclosure provide an information processing apparatus, including: a first receiving module, configured to receive the satellite coverage information of the UE sent by the NWDAF.

The embodiments of the present disclosure provide an information processing apparatus, including: a first receiving module, configured to receive, via an NEF, the satellite coverage information of the UE sent by the NWDAF.

In some embodiments, the satellite coverage information of the UE is determined based on ephemeris information of a satellite accessed by the UE, and location information of the UE; or the satellite coverage information of the UE is determined based on the ephemeris information and movement trajectory information of the UE; or the satellite coverage information of the UE is determined based on the ephemeris information, the location information and the movement trajectory information.

The embodiments of the present disclosure provide an information processing apparatus, including a first processing module, configured to: determine, based on the satellite coverage information of the UE, whether the UE conducts a service in a current coverage time range; and/or determine, based on the satellite coverage information of the UE, whether the UE conducts a service in a next coverage time range.

The embodiments of the present disclosure provide an information processing apparatus, including: a first sending module 51, configured to send, before the UE is switched from a first service network to a second service network, the request to an H-NWDAF.

The embodiments of the present disclosure provide an information processing apparatus, including: a first receiving module, configured to receive, before the UE is switched from the first service network to the second service network, the satellite coverage information of the UE sent by the H-NWDAF, where the satellite coverage information of the UE is determined by the H-NWDAF based on the location related information obtained from the NWDAF of the first service network.

The embodiments of the present disclosure provide an information processing apparatus, including: a first receiving module, configured to receive, after the UE is switched from the first service network to the second service network, the satellite coverage information of the UE sent by the H-NWDAF, where the satellite coverage information of the UE is determined by the H-NWDAF based on the location related information obtained from the NWDAF of the second service network.

The embodiments of the present disclosure provide an information processing apparatus, including: a first sending module 51, configured to send, before the UE is switched from the first service network to the second service network, the request to the NWDAF of the first service network.

The embodiments of the present disclosure provide an information processing apparatus, including: a first receiving module, configured to receive, before the UE is switched from the first service network to the second service network, the satellite coverage information of the UE sent by the NWDAF of the first service network, where the satellite coverage information of the UE is determined by the NWDAF of the first service network based on the location related information as obtained.

The embodiments of the present disclosure provide an information processing apparatus, including: a first receiving module, configured to receive, after the UE is switched from the first service network to the second service network, the satellite coverage information of the UE sent by the NWDAF of the first service network, where the satellite coverage information of the UE is determined by the NWDAF of the first service network based on the location related information obtained from the NWDAF of the second service network.

Here, the NWDAF of the first service network is the S-NWDAF, and the NWDAF of the second service network is the H-NWDAF.

As shown in FIG. 9, the embodiments of the present disclosure provide an information processing apparatus, including:
a second receiving module 61, configured to receive a request sent by an AF, where the request is used for requesting satellite coverage information of a UE.

The information processing apparatus provided by the embodiments of the present disclosure may be applied in an NWDAF.

The embodiments of the present disclosure provide an information processing apparatus, including: a second receiving module 61, configured to receive, via an NEF, the request sent by the AF.

In some embodiments, the request is further used for indicating reachability information of the UE.

The embodiments of the present disclosure provide an information processing apparatus, including: a second sending module, configured to send the satellite coverage information of the UE to the AF.

The embodiments of the present disclosure provide an information processing apparatus, including: a second sending module, configured to send, via an NEF, the satellite coverage information of the UE to the AF.

The embodiments of the present disclosure provide an information processing apparatus, including: a second processing module, configured to obtain location related information, and determine, based on the location related information, the satellite coverage information of the UE.

In some embodiments, the location related information includes at least one of: ephemeris information of a satellite accessed by the UE, location information of the UE, and movement trajectory information of the UE.

The embodiments of the present disclosure provide an information processing apparatus, including a second processing module that is configured to: determine the satellite coverage information based on the ephemeris information and the location information; or determine the satellite coverage information based on the ephemeris information and the movement trajectory information of the UE; or determine the satellite coverage information based on the ephemeris information, the location information and the movement trajectory information.

In some embodiments, the NWDAF includes an S-NWDAF; and the second processing module is configured to obtain the location related information from a T-NWDAF.

The embodiments of the present disclosure provide an information processing apparatus, including: a second processing module, configured to obtain, before the UE is switched from a first service network to a second service network, the location related information.

The embodiments of the present disclosure provide an information processing apparatus, including: a second processing module, configured to obtain, after the UE is switched from the first service network to the second service network, the location related information from the NWDAF of the second service network.

It should be noted that those skilled in the art can understand that the apparatuses provided in the embodiments of the present disclosure may be performed individually or in combination with some apparatuses in the embodiments of the present disclosure or some apparatuses in the related art.

With respect to the apparatus in the above embodiments, the specific manner in which each module performs an operation has been described in detail in the embodiments relating to the method, and will not be described in detail here.

The embodiments of the present disclosure provide a communication device, including:
a processor; and
a memory, configured to store an executable instruction of the processor; where the processor, when running the executable instruction, is configured to implement the information processing method of any embodiment of the present disclosure.

In an embodiment, the communication device may include, but is not limited to, at least one of: an AF, an NWDAF, an NEF, a UPF, and a UE.

In some embodiments, the processor may include various types of storage media, where the storage media are non-transitory computer storage media capable of continuing to memorize information stored thereon after the UE is powered down.

The processor may be connected to the memory via a bus or the like for reading an executable program stored in the memory, for example, at least one of the methods shown in FIGS. 2 to 7.

The embodiments of the present disclosure also provide a computer storage medium. The computer storage medium stores an executable program of a computer. The executable program, when executed by a processor, implements the information processing method of any embodiment of the present disclosure, for example, at least one of the methods shown in FIGS. 2 to 7.

With respect to the device or storage medium in the above embodiments, the specific manner in which each module performs an operation has been described in detail in the embodiments relating to the method, and will not be described in detail here.

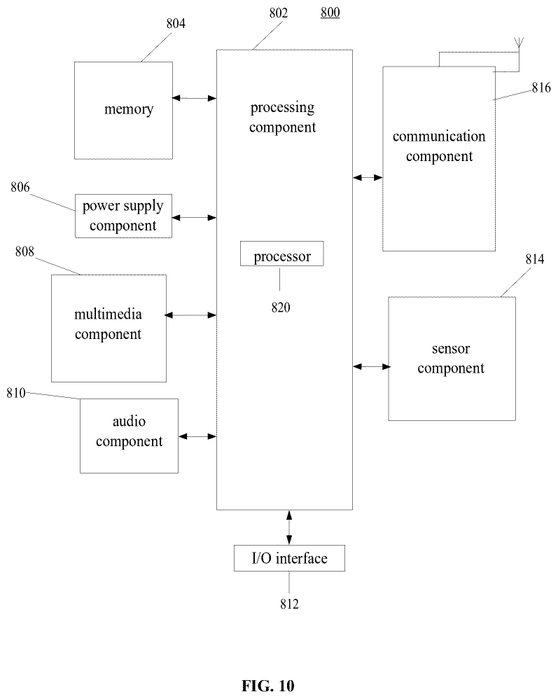

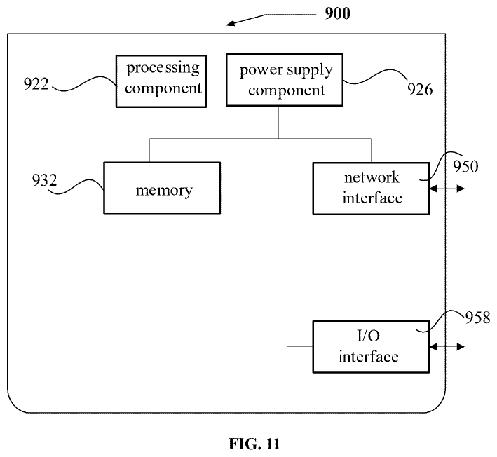

FIG. 10 is a block diagram of a UE 800 illustrated according to an exemplary embodiment. For example, the UE 800 may be a mobile phone, a computer, a digital broadcast user equipment, a message transceiver device, a game console, a tablet device, a medical device, a fitness device, or a personal digital assistant.

Referring to FIG. 10, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the UE 800, such as operations associated with display, telephone calls, data communication, camera operations, and recording operations. The processing component 802 may include one or more processors 820 to execute an instruction to generate all or part of the steps of the method described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support the operations on the UE 800. Examples of such data include the following: an instruction of any application program or method operated on the UE 800, contact data, phonebook data, messages, pictures, videos, etc. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 806 supplies power to various components of the UE 800. The power supply component 806 may include a power supply management system, one or more power supplies, and other components associated with generating, managing and distributing power for the UE 800.

The multimedia component 808 includes a screen that provides an output interface between the UE 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe operation. In an embodiment, the multimedia component 808 includes a front-facing camera and/or a rear-facing camera. The front-facing camera and/or the rear-facing camera may receive external multimedia data when the UE 800 is in an operating mode, such as a shooting mode or a video mode. Each of the front-facing camera and the rear-facing camera may be a fixed optical lens system or have a focal length and optical zoom capability.

The audio component 810 is configured to output and/or input audio signals. For example, the audio component 810 includes a microphone (MIC), configured to receive external audio signals when the UE 800 is in an operating mode, such as a calling mode, a recording mode and a voice recognition mode. The received audio signals may be further stored in the memory 804 or sent via the communication component 816. In some embodiments, the audio component 810 further includes a speaker for outputting the audio signals.

The I/O interface 812 provides an interface between the processing component 802 and a peripheral interface module, and the peripheral interface module may be a keypad, a click wheel, a button, etc. These buttons may include, but are not limited to, a home button, a volume button, a start button, and a lock button.

The sensor component 814 includes one or more sensors configured to provide status assessment of various aspects of the UE 800. For example, the sensor component 814 may detect an open/closed state of the device 800, relative positioning of the components, for example, the components are the display and small keypad of the UE 800. The sensor component 814 may also detect a change in the position of the UE 800 or a change in the position of one component of the UE 800, the presence or absence of contact between the user and the UE 800, the orientation or acceleration/deceleration of UE 800, and temperature changes of the UE 800. The sensor component 814 may include a proximity sensor that is configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the UE 800 and other devices by wired or wireless means. The UE 800 may access a wireless network based on a communication standard, such as WiFi, 4G, 5G, or a combination thereof. In an exemplary embodiment, the communication component 816 receives broadcast signals or broadcast related information from an external broadcast management system via a broadcast channel. In an exemplary embodiment, the communication component 816 further includes a near-field communication (NFC) module to facilitate short-range communication. For example, the NFC module may be implemented based on the radio frequency identification (RFID) technology, the infrared data association (IrDA) technology, the ultra-wideband (UWB) technology, the bluetooth (BT) technology, or other technologies.

In an exemplary embodiment, the UE 800 may be implemented by one or more of the following: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, to perform the methods described above.

In an exemplary embodiment, a non-transitory computer-readable storage medium including an instruction is provided, such as the memory 804 including an instruction. The instruction described above is capable of being executed by the processor 820 of the UE 800 to complete the methods described above. For example, the non-transitory computer-readable storage medium may be an ROM, a random access memory (RAM), a CD-ROM, a magnetic tape, a floppy disk, or an optical data storage device.

As shown in FIG. 11, an embodiment of the present disclosure illustrates a structure of a base station. For example, the base station 900 may be provided as a network side device. Referring to FIG. 11, the base station 900 includes a processing component 922, where the processing component 922 further includes one or more processors, and a memory resource represented by a memory 932 for storing an instruction, such as an application program, that is executable by the processing component 922. The application program stored in the memory 932 may include one or more modules each corresponding to a set of instructions. In addition, the processing component 922 is configured to execute the instruction to perform any method described above applied to the base station.

The base station 900 may further include a power supply component 926 configured to perform power management of the base station 900, a wired or wireless network interface 950 configured to connect the base station 900 to the network, and an I/O interface 958. The base station 900 may operate an operating system stored in the memory 932, such as Windows Server™, Mac OS X™, Unix™, Linux™, FreeBSD™, or the like.

After considering the specification and practicing the invention disclosed herein, those skilled in the art will easily come up with other implementation solutions of the present invention. The present disclosure is intended to cover any variations, uses or adaptive changes of the present invention, and the variations, uses or adaptive changes follow the general principles of the present invention and include common knowledge or commonly used technical means in the technical field that is not disclosed in the present disclosure. The specification and embodiments are only considered to be exemplary, and the true scope and spirit of the present invention are indicated by the following claims.

It should be understood that the present invention is not limited to the precise structure which has been described above and illustrated in the accompanying drawings, and that various modifications and alterations may be made without departing from the scope of the present invention. The scope of the present invention is limited only by the appended claims.

1. An information processing method, performed by an application function (AF), comprising:
sending a request to a network data analytics function (NWDAF), wherein the request is used for requesting satellite coverage information of a user equipment (UE).

2. The method according to claim 1, wherein the sending the request to the NWDAF comprises:
sending the request to the NWDAF via a network exposure function (NEF).

3. The method according to claim 1, wherein the request is further used for indicating reachability information of the UE.

4. The method according to claim 1, further comprising:
receiving the satellite coverage information of the UE sent by the NWDAF.

5. The method according to claim 4, wherein the receiving the satellite coverage information of the UE sent by the NWDAF comprises:
receiving, via an NEF, the satellite coverage information of the UE sent by the NWDAF.

6. The method according to claim 1, wherein
the satellite coverage information of the UE is determined based on ephemeris information of a satellite accessed by the UE, and location information of the UE; or
the satellite coverage information of the UE is determined based on the ephemeris information and movement trajectory information of the UE; or
the satellite coverage information of the UE is determined based on the ephemeris information, the location information and the movement trajectory information.

7. The method according to claim 1, further comprising at least one of:
determining, based on the satellite coverage information of the UE, whether the UE conducts a service in a current coverage time range; or
determining, based on the satellite coverage information of the UE, whether the UE conducts a service in a next coverage time range.

8. An information processing method, performed by a network data analytics function (NWDAF), comprising:
receiving a request sent by an application function (AF), wherein the request is used for requesting satellite coverage information of a user equipment (UE).

9. The method according to claim 8, wherein the receiving the request sent by the AF comprises:
receiving, via a network exposure function (NEF), the request sent by the AF.

10. The method according to claim 8, wherein the request is further used for indicating reachability information of the UE.

11. The method according to claim 8, further comprising:
sending the satellite coverage information of the UE to the AF.

12. The method according to claim 11, wherein the sending the satellite coverage information of the UE to the AF comprises:
sending, via an NEF, the satellite coverage information of the UE to the AF.

13. The method according to claim 8, further comprising:
obtaining location related information; and
determining, based on the location related information, the satellite coverage information of the UE.

14. The method according to claim 13, wherein the location related information comprises at least one of: ephemeris information of a satellite accessed by the UE, location information of the UE, or movement trajectory information of the UE; and
the determining, based on the location related information, the satellite coverage information of the UE comprises one of:
determining the satellite coverage information based on the ephemeris information and the location information;
determining the satellite coverage information based on the ephemeris information and the movement trajectory information of the UE; or
determining the satellite coverage information based on the ephemeris information, the location information and the movement trajectory information.

15. The method according to claim 13, wherein the NWDAF comprises a source network data analytics function (S-NWDAF); and
the obtaining the location related information comprises:
obtaining the location related information from a target network data analytics function (T-NWDAF).

16-17. (canceled)

18. A communication device, comprising:
a processor; and
a memory, configured to store an executable instruction of the processor; wherein the processor, through running the executable instruction, is configured to:
send a request to a network data analytics function (NWDAF), wherein the request is used for requesting satellite coverage information of a user equipment (UE).

19. A non-transitory computer-readable storage medium, storing an executable program of a computer, wherein the executable program, when executed by a processor, causes the processor to perform the information processing method according to claim 1.

20. A communication device, comprising:
a processor; and
a memory, configured to store an executable instruction of the processor; wherein
the processor, through running the executable instruction, is configured to perform the information processing method according to claim 8.

21. A non-transitory computer-readable storage medium, storing an executable program of a computer, wherein the executable program, when executed by a processor, causes the processor to perform the information processing method according to claim 8.

22. The communication device according to claim 18, wherein the processor is specifically configured to:
send the request to the NWDAF via a network exposure function (NEF).
